(19) United States
(12) Patent Application Publication
(10) Pub. No.: US 2009/0050661 A1
(43) Pub. Date: Feb. 26, 2009

(54) Glass Cutting Apparatus With Bending Member and Method Using Thereof

(76) Inventors: Youn-Ho Na, Gyeonggi-Do (KR); Byung-Jin Jung, Gyeongbuk (KR); Jun-Young Woo, Daegu (KR); Mu-Kyun Park, Gyoungbuk (KR); Jung Hyun Kim, Gyeongbuk (KR)

Correspondence Address: SUGHRUE MION, PLLC, 2100 PENNSYLVANIA AVENUE, N.W., SUITE 800, WASHINGTON, DC, 20037, US

(21) Appl. No.: 12/294,269

(22) PCT Filed: May 25, 2006
(86) PCT No.: PCT/KR06/01984

§ 371 Date: Sep. 24, 2008

(30) Foreign Application Priority Data
Mar. 24, 2006 (KR) 10-2006-0026929
May 17, 2006 (KR) 10-2006-0044142
May 17, 2006 (KR) 10-2006-0044143

(51) Int. Cl. B26F 3/00

(52) U.S. Cl. 225/2; 225/96.5

(57) ABSTRACT

Disclosed herein is glass cutting apparatuses and methods of cutting glass using the glass cutting apparatuses. More particularly, disclosed is a glass cutting apparatus which cuts a glass sheet (140) by forming a crack in the glass sheet using a laser beam and by lifting the glass sheet using a bending unit (160), and a method of cutting glass using the glass cutting apparatus.

### TECHNICAL FIELD

The present invention relates, in general, to a glass cutting apparatus and a method of cutting glass using the glass cutting apparatus and, more particularly, to a glass cutting apparatus which cuts a glass sheet by forming a crack in the glass sheet using a laser beam and lifting the glass sheet using a bending unit, and a method of cutting glass using the glass cutting apparatus.

### BACKGROUND ART

In conventional arts, to cut glass sheets, blades provided with diamonds at ends thereof have been used.

However, the conventional cutting method has problems in that cut ends of a glass sheet are inferior and in that it is not suitable for cutting large or thick glass sheets.

To solve the above problems, recently, a method of cutting a glass sheet using a laser beam has been used. In this method, a glass sheet is placed on a stage unit and, thereafter, a laser beam is radiated onto the glass sheet, thus cutting the glass sheet.

In this case, the glass sheet is cut using repulsive force generated at an interface that is newly created between cut parts of the glass sheet when the glass sheet is cut, that is, at the cut ends of the glass sheet. However, for a glass sheet which is large and thus heavy, friction is high.

Such friction acts as stress interfering with cutting. Thus, a cutting process is not easily conducted, and, even if the cutting process is completed, the quality of cut ends of the glass sheet is low.

### DISCLOSURE OF INVENTION

### Technical Problem

In the conventional cutting apparatus, because the stage unit is in surface contact with the glass sheet, relatively high friction exists between the stage unit and the glass sheet. Thus, when the glass sheet is cut, left and right cut parts of the glass sheet do not easily slide in left and right directions relative to a cutting line.

Therefore, the cutting process is not smoothly conducted, and the quality of cut ends of the glass sheet suffers. As well, because a large amount of energy is required for the cutting process, efficiency is low and energy is wasted.

### Technical Solution

Accordingly, the present invention has been made keeping in mind the above problems occurring in the prior art, and an object of the present invention is to provide a glass cutting apparatus having a bending unit which minimizes friction between a glass sheet and a stage unit when cutting the glass sheet, thus easily cutting the glass sheet using a relatively small amount of energy, and a method of cutting glass using the same.

### Advantageous Effects

In the glass cutting apparatus having a bending unit and the method of cutting glass using the same according to the present invention, there are the following advantages.

First, because the bending unit is provided such that the upper end thereof is disposed higher than the upper surface of a stage unit, a medial portion of a glass sheet is lifted while opposite ends thereof sag. Thus, stress is concentrated on the medial portion of the glass sheet to be cut. Hence, the glass sheet can be easily cut even using relatively little energy.

Particularly, the bending unit is disposed behind a laser generating unit, so that the bending unit pushes a cut part of the glass sheet upwards, thus making it easy to conduct the cutting process.

Second, the degree of bending of the glass sheet can be controlled by adjusting the height of the bending unit. Therefore, depending on the thickness and size of the glass sheet, the intensity of stress applied to a desired part of the glass sheet to be cut can be adjusted.

Third, a plurality of air suction holes is formed in the stage unit, so that the glass sheet is prevented from undesirably sliding, and the air suction holes along with the bending unit can further bend the medial portion of the glass sheet, that is, the part to be cut. Therefore, stress is further concentrated on the desired part of the glass sheet, thus the glass sheet can be cut using relatively little energy more easily.

Fourth, the bending unit is coupled to the laser generating unit by a support unit, so that, despite having a simple structure, the bending unit can be constructed to integrally move with the laser generating unit.

Fifth, the support unit extends from the laser generating unit in a sideways direction, surrounds a side edge of the stage unit, and is coupled to the bending unit. Therefore, the support unit is prevented from interfering with the glass sheet when cut.

Sixth, a support unit may be mounted to a rear portion of a laser generating unit and be coupled to a bending unit, such that the cutting apparatus can cut any size of glass sheet. Furthermore, the support unit may be manufactured such that it is thin and an edge thereof is sharp, so that the support unit pushes the cut ends of the glass sheet in opposite directions, thus conducting the cutting process more easily and rapidly.

Seventh, a first carrying unit, which moves the laser generating unit forwards and backwards, and a second carrying unit, which moves the bending unit forwards and backwards, may be provided. In this case, the first and second carrying units are controlled by a control unit such that a laser generating unit and a bending unit are moved at the same speed, therefore a glass sheet can be pushed upwards by the bending unit while the laser generating unit radiates a laser beam onto the glass sheet.

Furthermore, because the bending unit and the laser generating unit are not directly coupled through a connection structure, nothing interferes with the glass sheet when the glass sheet is cut, thus the cutting apparatus can cut any size of glass sheet.

Eighth, the present invention cuts a glass sheet using a method of forming a crack in the glass sheet and lifting the glass sheet. Accordingly, a large glass sheet can be easily cut using a relatively low energy laser beam, and the quality of cut ends of the glass sheet is superior.

Ninth, because the bending unit pushes the glass sheet upwards while following the laser generating unit at a speed equal to that of the laser generating unit, the relationship between the position at which a laser beam irradiates the glass sheet and the position at which the glass sheet is lifted remains constant. Therefore, the intensity of the laser beam can be adjusted more easily.

Tenth, after the glass sheet has been lifted, the laser beam is radiated onto the glass sheet at an intensity lower than that before the glass sheet is lifted, thus saving energy, that is, cutting the glass sheet using minimum energy, and ensuring superior quality of cut ends of the glass sheet.

Furthermore, the laser beam is gradually reduced in intensity from the leading end of the glass sheet to a trailing end, so that the glass sheet can be cut using the minimum energy required to cut the glass sheet, thus saving energy and enhancing the quality of cut ends of the glass sheet.

Moreover, in the case where the trailing end of the glass sheet is rounded, an intensity of laser beam higher than in the case where the trailing end of the glass sheet is cut straight is irradiated onto the glass sheet. As such, the intensity of the laser beam is adjusted depending on whether the trailing end of the glass sheet is rounded or is cut straight, thus cutting the glass sheet using minimum energy, and enhancing the quality of the cut ends thereof.

### BRIEF DESCRIPTION OF THE DRAWINGS

FIG. 1 is a perspective view of a glass cutting apparatus, according to a first embodiment of the present invention;

FIG. 2 is a side view of the glass cutting apparatus, according to the first embodiment of the present invention;

FIG. 3 is front views of the glass cutting apparatus, according to the first embodiment of the present invention;

FIG. 4 is a perspective view of a glass cutting apparatus, according to a second embodiment of the present invention;

FIG. 5 is a side view of the glass cutting apparatus, according to the second embodiment of the present invention;

FIG. 6 is a perspective view of a glass cutting apparatus, according to a third embodiment of the present invention; and

FIG. 7 is graphs showing changes in intensity of a laser beam when cutting a glass sheet according to the present invention.

### MODE FOR THE INVENTION

In order to accomplish the above object, in an aspect, the present invention provides a glass cutting apparatus, including: a laser generating unit generating a laser beam and radiating the laser beam onto a glass sheet while moving forwards or backwards; a stage unit provided below the laser generating unit and supporting the glass sheet thereon, with a guide path formed at a medial position in the stage unit; a bending unit provided in the guide path at a position adjacent to the laser generating unit and disposed such that an upper end thereof is higher than an upper surface of the stage unit, the upper end of the bending unit contacting the glass sheet; and a moving means for moving the bending unit.

The bending unit may include: a body moving forwards and backwards along the guide path; a roller or ball provided on an upper end of the body and contacting the glass sheet; and a bending height adjusting member to adjust a height of the roller or ball.

Furthermore, an air suction hole communicating with a vacuum pump may be formed in the stage unit.

The moving means may comprise a support unit coupling and fastening the bending unit to the laser generating unit. The support unit may extend from the laser generating unit in a sideways direction, surround a side edge of the stage unit, and be coupled to the bending unit.

The moving means may comprise a support unit coupling and fastening the bending unit to the laser generating unit. The support unit may be mounted to a rear portion of the laser generating unit and be coupled to the bending unit.

The moving means may include: a first carrying unit moving the laser generating unit forwards and backwards; a second carrying unit moving the bending unit forwards and backwards; and a control unit controlling moving speeds of the first carrying unit and the second carrying unit.

In another aspect, the present invention provides a method of cutting glass using a laser beam, including: a irradiating step of radiating a laser beam onto a glass sheet to form a crack in the glass sheet; and a cutting step of cutting the glass sheet by lifting a portion of the glass sheet at which the crack is formed.

At the cutting step, the bending unit may follow the laser generating unit at a speed equal to a moving speed of the laser generating unit radiating the laser beam while lifting the glass sheet.

At the irradiating step, after the glass sheet is lifted at the cutting step, the laser beam may be radiated onto the glass sheet at an intensity lower than that before the glass sheet is lifted.

At the irradiating step, the laser beam may be gradually reduced in intensity from a leading end of the glass sheet to a trailing end.

At the irradiating step, in a case where a trailing end of the glass sheet is rounded, a laser beam may be irradiated onto the glass sheet at an intensity of higher than in a case where the trailing end of the glass sheet is cut straight.

Hereinafter, preferred embodiments of the present invention will be described in detail with reference to the attached drawings.

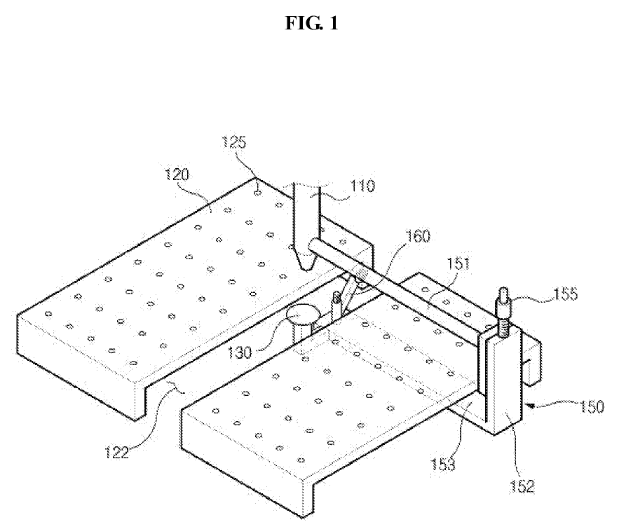

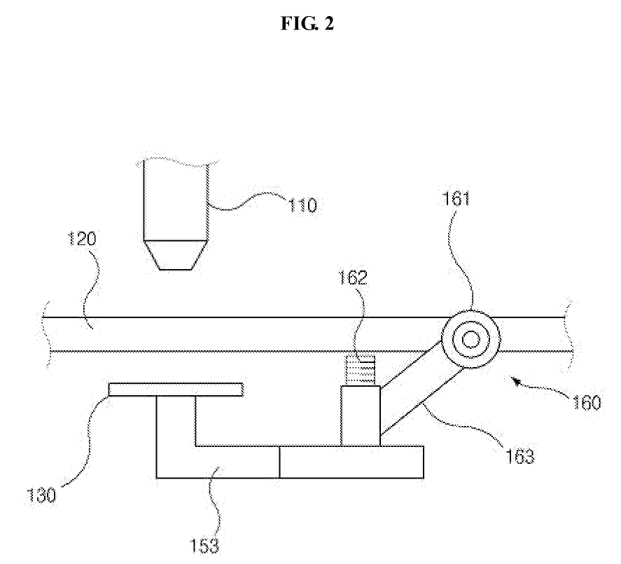

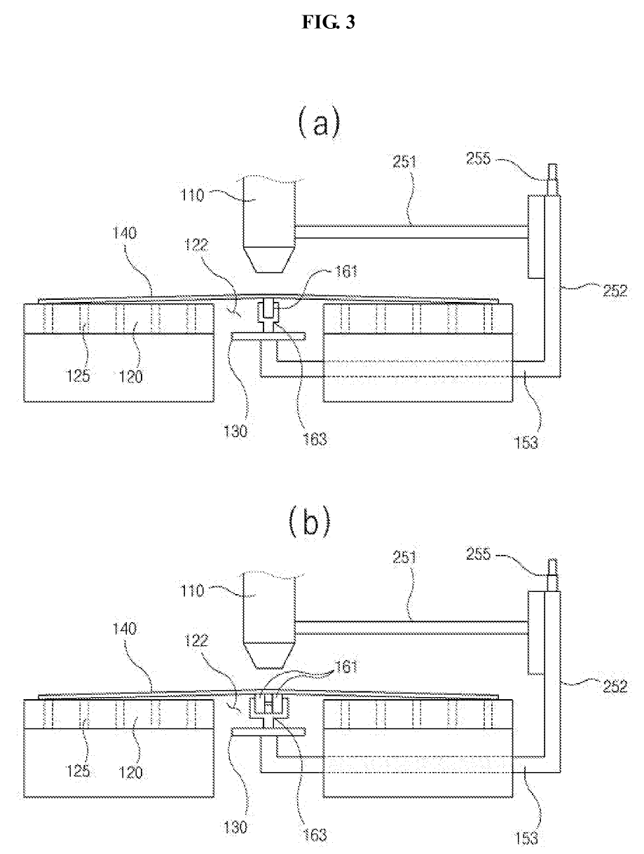

FIG. 1 is a perspective view of a glass cutting apparatus, according to a first embodiment of the present invention. FIG. 2 is a side view of the glass cutting apparatus, according to the first embodiment of the present invention. FIG. 3 is front views of the glass cutting apparatus, according to the first embodiment of the present invention.

As shown in FIGS. 1 through 3, the first embodiment includes a laser generating unit 110, a stage unit 120, a lower reflecting plate 130, a support unit 150 and a bending unit 160.

The laser generating unit 110 generates a laser beam and radiates it onto a glass sheet 140, in the same manner as a conventional laser generating unit 110. The laser generating unit 110 moves forwards and backwards.

The stage unit 120 is provided below the laser generating unit 110 and supports the glass sheet 140 thereon. A guide path 122, along which the lower reflecting plate 130 and the bending unit 160 are moved, is formed at a medial position through the stage unit 120.

The guide path 122 may be a groove, which is formed by concavely machining the upper surface of the stage unit 120, or, alternatively, may be a gap defined between two separated bodies of the stage unit 120, as shown in FIGS. 1 and 3.

The lower reflecting plate 130 is disposed directly below the laser generating unit 110 and is moved along the guide path 122, that is, along the space defined between two bodies of the stage unit 120.

The lower reflecting plate 130 serves to reflect a laser beam, which is radiated from the laser generating unit 110.

It is preferable that the lower reflecting plate 130 be circular and have almost the same size as the thickness of the laser generating unit 110.

Furthermore, preferably, an upper reflecting plate (not shown) is provided below the laser generating unit 110 above the lower reflecting plate 130 and the glass sheet 140, such that the laser beam reflected by the lower reflecting plate 130 is again reflected by the upper reflecting plate, that is, such that the laser beam can repeatedly irradiate the glass sheet 140.

The support unit 150 is a moving means for simultaneously moving the bending unit 160 and the laser generating unit 110. In other words, the support unit 150 couples the bending unit 160 to the laser generating unit 110 such that the bending unit 160 can be moved along with the laser generating unit 110.

With such construction, the lower reflecting plate 130 can be manufactured to have a relatively small size, and a laser beam can always be exactly reflected by the lower reflecting plate 130.

As shown in FIGS. 1 and 3, the support unit 150 extends from the laser generating unit 110 in a lateral direction, surrounds the edge of the stage unit 120, and is connected to the lower reflecting plate 130 and the bending unit 160.

Therefore, the lower reflecting plate 130 and the bending unit 160 are integrated with and moved along with the laser generating unit 110 by the support unit 150.

The support unit 150 includes an upper horizontal member 151, which is coupled to the laser generating unit 110 and extends in a horizontal direction above the stage unit 120, a lower horizontal member 153, which is coupled to the lower reflecting plate 130 and the bending unit 160 and extends in a horizontal direction below the stage unit 120, and a vertical member 152, which couples the upper horizontal member 151 and the lower horizontal member 153 to each other.

Here, the vertical member 152 comprises two bodies, which are slidably coupled to each other. A height adjusting member 155 is mounted to the vertical member 152, so that the length of the vertical member 152 can be adjusted using the height adjusting member 155.

A micrometer, which is well-known, is used as the height adjusting member 155, such that the length of the vertical member 152 can be precisely and easily adjusted. The heights of the lower reflecting plate 130 and the bending unit 160 are also adjusted by the height adjusting member 155.

Furthermore, a horizontal length adjusting member (not shown) may be mounted to the upper horizontal member 151 or the lower horizontal member 153 of the support unit 150 such that the horizontal length thereof is adjustable.

The bending unit 160 is constructed such that it is movable along the guide path 122, that is, along the space defined between two bodies of the stage unit 120. The bending unit 160 is disposed such that an upper end thereof is placed at a position higher than the upper surface of the stage unit 120. The glass sheet 140 is placed on the upper end of the bending unit 160.

Furthermore, the bending unit 160 is disposed below and ahead of or behind the laser generating unit 110 and at a position adjacent to the laser generating unit 110.

That is, the bending unit 160 is disposed ahead of or behind the lower reflecting plate 130 and is moved along with the lower reflecting plate 130.

The bending unit 160 includes a body 163, which moves forwards and backwards along the guide path 122, a roller 161 or freely rotatable ball, which is provided on an upper end of the body 163 and contacts the glass sheet, and a bending height adjusting member 162, which adjusts the height of the roller 161 or the ball.

As shown in FIGS. 2 and 3, the bending unit 160 is constructed such that the upper end thereof, that is, the roller 161 or the ball, is disposed higher than the upper surface of the stage unit 120.

As shown in FIG. 3(a), a single roller 161 may be provided at a position corresponding to the central axis of the body 163 such that it is aligned with the laser generating unit 110 and the lower reflecting plate 130 in the same vertical line. Alternatively, as shown in FIG. 3(b), one roller 161 may be provided at each of opposite sides of the body 163, that is, two rollers 161 may be provided, so that the vertical axis, which connects the laser generating unit 110 and the lower reflecting plate 130 to each other, passes between the two rollers 161.

Due to the bending unit 160 structured as described above, when the glass sheet 140 is placed on the stage unit 120, as shown in FIG. 3, because the upper end of the bending unit 160 is higher than the upper surface of the stage unit 120, a medial portion of the glass sheet 140, which contacts the upper end of the bending unit 160, that is, the roller 161, protrudes upwards while the opposite ends of the glass sheet 140 sag downwards due to their weight, and contact the stage unit 120. Thus, the glass sheet 140 forms a shape which is inclined downwards from the medial portion thereof to the opposite ends thereof.

In the above state, the stress of the bending force is concentrated on the medial portion of the glass sheet 140. At this time, a laser beam is radiated onto the medial portion of the glass sheet 140 using the laser generating unit 110, so that the glass sheet 140 can be cut using relatively little energy.

Furthermore, in the present invention, the bending unit 160 may be placed behind the lower reflecting plate 130. Therefore, even if only a weak laser beam is radiated onto the glass sheet 140, because the bending unit 160 pushes the glass sheet 140 upwards, the glass sheet 140 can be easily cut.

Here, in the case that the single roller 161 is provided, as described above with reference to FIG. 3(a), the roller 161 pushes the glass sheet 140 upwards at a position directly below a cutting line formed in the glass sheet 140. In the case that two rollers 161 are provided, as described above with reference to FIG. 3(b), the two rollers 161 push the glass sheet 140 upwards at opposite sides below the cutting line formed in the glass sheet 140.

Meanwhile, preferably, a plurality of air suction holes 125 is formed through the stage unit 120 and is connected to a vacuum pump.

Thus, after the glass sheet 140 is placed on the stage unit 120, air which exists between the stage unit 120 and the glass sheet 140 is discharged through the air suction holes 125, such that the glass sheet 140 is biased in the direction in which the glass sheet 140 is brought into close contact with the stage unit 120. Thus, stress caused by the bending unit 160 is concentrated on the medial portion of the glass sheet 140 more strongly, and the glass sheet 140 is prevented from undesirably moving due to the roller 161 of the bending unit 160.

Here, preferably, the number and positions of air suction holes 125 are symmetrical based on the cutting line of the glass sheet 140. As well, it is preferable that suction pressure be evenly applied to the glass sheet 140.

This is realized by placing the glass sheet 140 on the stage unit 120 such that the air suction holes 125 are disposed in the same number and at symmetrical positions of the left and right sides of the glass sheet 140 relative to the line along which the glass sheet 140 is cut.

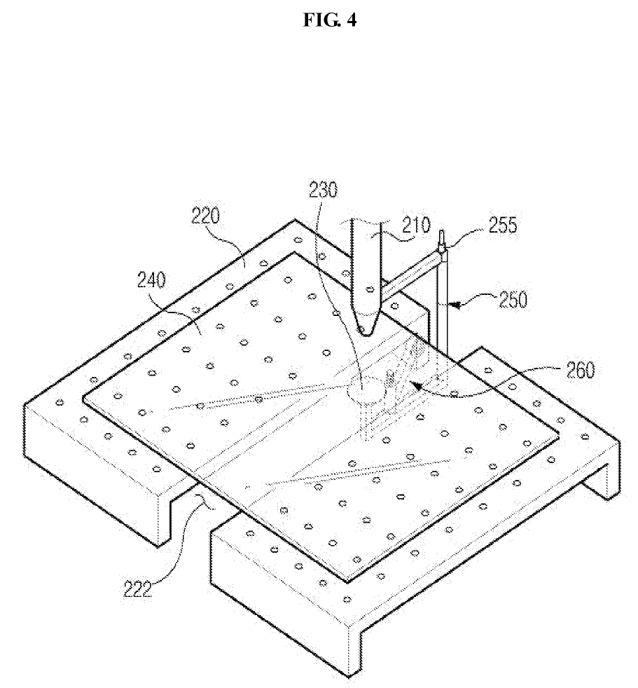

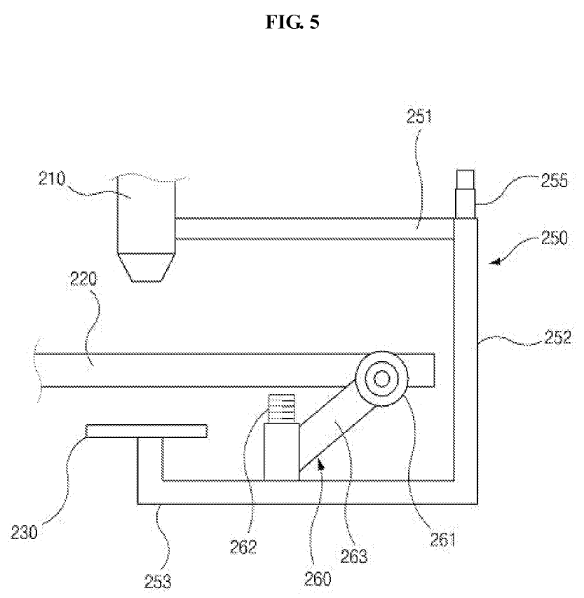

FIG. 4 is a perspective view of a glass cutting apparatus, according to a second embodiment of the present invention. FIG. 5 is a side view of the glass cutting apparatus according to the second embodiment of the present invention.

As shown in FIGS. 4 and 5, the second embodiment includes a laser generating unit 210, a stage unit 220, a lower reflecting plate 230, a support unit 250 and a bending unit 260.

The constructions of the laser generating unit 210, the stage unit 220, which is provided with a guide path 222 and air suction holes 225, the lower reflecting plate 230 and the bending unit 260 are the same as those of the first embodiment, therefore further explanation will be omitted, and the support member 250 will be mainly explained.

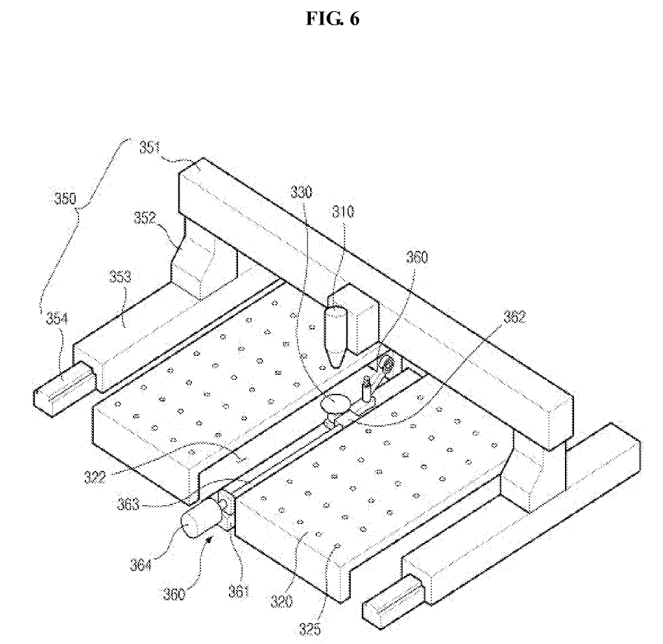

As shown in FIGS. 5 and 6, the support member 250 is provided behind the laser generating unit 210 and is coupled to the lower reflecting plate 230 and the bending unit 260.

Therefore, the lower reflecting plate 230 and the bending unit 260 are integrated with the laser generating unit 210 through the support unit 250, thus the lower reflecting plate 230 moves along with the laser generating unit 210.

The support unit 250 includes an upper horizontal member 251, which is coupled to a rear portion of the laser generating unit 110, a lower horizontal member 253, which is coupled to the lower reflecting plate 230 and extends a predetermined length backwards, and a vertical member 252, which couples the upper horizontal member 251 and the lower horizontal member 253 to each other.

Here, the vertical member 252 comprises two bodies, which are slidably coupled to each other. A height adjusting member 255 is mounted to the vertical member 252, so that the length of the vertical member 252 is adjusted using the height adjusting member 255.

Furthermore, the vertical member 252 is disposed behind the bending unit 260.

A micrometer, which is well-known, is used as the height adjusting member 255, such that the length of the vertical member 252 can be precisely and easily adjusted. The height of the lower reflecting plate 230 is also adjustable by the height adjusting member 255.

Preferably, the part of the vertical member 252 that contacts a glass sheet 240 is thin, and the height adjusting member 255 is provided on an upper end of the vertical member 252, that is, on the part of the vertical member 252 that does not contact the glass sheet 240.

In this embodiment having the above-mentioned construction, after a cutting line, that is, a gap, is formed in the glass sheet by a laser beam radiated onto the glass sheet 240 from the laser generating unit 210, the vertical member 252, which follows along behind the laser beam, enters the cutting line and thus separates cut parts of the glass sheet 240, thus cutting the glass sheet 240 more rapidly.

FIG. 6 is a perspective view of a glass cutting apparatus, according to a third embodiment of the present invention.

As shown in FIG. 6, the third embodiment includes a laser generating unit 310, a stage unit 320, a lower reflecting plate 330, a moving means, a bending unit 360 and a control unit (not shown).

The constructions of the laser generating unit 310, the stage unit 320, which is provided with a guide path 322 and air suction holes 325, the lower reflecting plate 330 and the bending unit 360 are the same as those of the first embodiment, therefore further explanation will be omitted, and the moving means and the control unit will be mainly explained.

The moving means includes a first carrying unit 350, which moves the laser generating unit 310 forwards and backwards, and a second carrying unit 360, which moves the lower reflecting plate 330 and/or the bending unit 360 forwards and backwards.

The first carrying unit 350 includes a horizontal support bar 351, which is coupled to the laser generating unit 310, a vertical support bar 352, which extends downwards from each of opposite ends of the horizontal support bar 351, a first base member 354, which is provided on a support surface in a direction parallel to the guide path 322 of the stage unit 320, and a slider 353, which is provided under each vertical support bar 352 and is slidably coupled to each first base member 354.

As the sliders 353 move forwards or backwards along the first base members 354, the vertical support bars 353 and the horizontal support bar are moved along with the sliders 353. Thereby, the laser generating unit 310 also moves forwards or backwards along the guide path 322.

Here, the sliders 353 are automatically moved using a well known motor and gear mechanism. The coupling structure between each slider 353 and each first base member 354 may be realized by a well known rail structure, or, alternatively, may be realized by a structure in which a slide slot is formed in the first base member 354, a protrusion is provided on the slider 353, and the protrusion is inserted into the slide slot such that the slider 353 is slidable. As such, the coupling structure between each slider 353 and each first base member 354 can be realized as one of various well-known sliding structures.

The second carrying unit 360 includes a second base member 361, which is placed in the guide path 322, a body part 362, which is slidably coupled to the second base member 361 and is coupled on an upper surface thereof to the lower reflecting plate 330 and the bending unit 360, and a motor 364 and a screw 363, which move the body part 362.

The screw 363 is mounted to an output shaft of the motor 364, and a threaded through hole is formed in the body part 362. The screw 363 is inserted into the threaded through hole, so that, when the motor 364 rotates, the body part 362 is moved forwards or backwards along the second base member 361.

The control unit controls the first carrying unit 350 and the second carrying unit 360. In detail, the control unit controls the first carrying unit 350 and the second carrying unit 360 such that the laser generating unit 310, the lower reflecting plate 330 and the bending unit 360 move at the same speed.

Therefore, the laser generating unit 310 and the lower reflecting plate 330 are moved at the same speed by the first carrying unit 350, the second carrying unit 360 and the control unit, so that the lower reflecting plate 330 is always placed directly below the laser generating unit 310. Furthermore, the bending unit 360, which pushes the glass sheet upwards, is disposed ahead of or behind the lower reflecting plate 330.

In this construction, because the bending unit 360 pushes the glass sheet upwards, stress is concentrated on the part of the glass sheet that is lifted by the bending unit 360. The part of the glass sheet on which stress is concentrated is cut using the laser generating unit 310. Therefore, the glass sheet can be cut using relatively little energy. As well, in the case that the bending unit 360 is disposed behind the laser generating unit 310, it may serve to push cut parts of the glass sheet in opposite directions.

Meanwhile, a method of cutting a glass sheet using the cutting apparatus of the present invention having the above-mentioned construction includes an irradiating step of radiating a laser beam onto a glass sheet to form a crack in the glass sheet, and a cutting step of cutting the glass sheet by lifting the portion of the glass sheet at which the crack is formed.

In the irradiating step, the glass sheet may be completely cut, or, alternatively, preferably form the crack in the glass sheet without completely cutting it. At the cutting step, the cut parts of the glass sheet are completely separated along the crack by lifting.

At this time, the roller, which is provided on the upper end of the bending unit, moves along the crack formed in the glass sheet, so that the crack parts of the glass sheet are separated along the crack, which is the weakest portion.

The cutting step is conducted by the bending unit, which moves at the same speed as the laser generating unit. Because the glass cutting apparatus is constructed such that the bending unit and the laser generating unit move at the same speed, the relationship between the position at which the laser beam irradiates the glass sheet and the position at which the glass sheet is pushed upwards is maintained constant. Therefore, the intensity of the laser beam can be adjusted more easily, as described below.

Meanwhile, at the irradiating step, after the glass sheet has been lifted at the cutting step, the laser beam is radiated onto the glass sheet at an intensity lower than that before the glass sheet is lifted.

The reason for this is that, when the glass sheet, in which the crack is formed by the laser beam, is lifted, the stress of the bending force is concentrated on the medial portion of the glass sheet which is lifted and, simultaneously, cut ends of the glass sheet are separated away from each other and cut parts of the glass sheet tend to move away from each other, therefore the glass sheet is easily cut even by a relatively low intensity laser beam.

Furthermore, at the irradiating step, the laser beam is gradually reduced in intensity from the leading end of the glass sheet to the trailing end.

The reason for this is that, as the cutting progresses, the cut ends of the glass sheet are separated gradually far away from each other and the cut parts of the glass sheet tend more strongly to move in directions away from each other, therefore the glass sheet can be easily cut even if the intensity with which the laser beam irradiates the glass sheet is reduced.

Furthermore, preferably, at a position spaced apart from the trailing end of the glass sheet by about 10 mm, the lowest intensity of laser beam is irradiated onto the glass sheet.

As well, at the irradiating step, in the case where the trailing end of the glass sheet is rounded, an intensity of laser beam higher than in the case where the trailing end of the glass sheet is cut straight by a laser beam is irradiated onto the glass sheet.

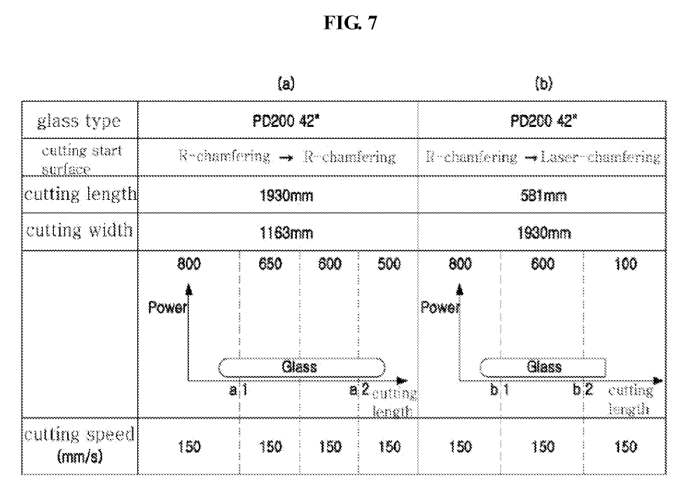

A method of adjusting the intensity of a laser beam is illustrated in the graphs of FIG. 7, showing the results of an experiment.

FIG. 7(a) is a graph showing the change in intensity of the laser beam when cutting a glass sheet, the trailing end of which is rounded. FIG. 7(b) is a graph showing the change in intensity of the laser beam when cutting a glass sheet, the trailing end of which is cut straight.

In this experiment, a PD200 42″ glass sheet was used, and the cutting speed of the laser generating unit radiating the laser beam was 150 mm/s.

In the case of FIG. 7(a), a glass sheet, leading and trailing ends of which are rounded (by R-chamfering), was used, and a cutting length thereof was 1930 mm and the width thereof was 1163 mm.

To crack the glass sheet, at an initial stage, a laser beam having an intensity of 800 W was radiated onto the glass sheet to form the crack. From the state (point a1) in which the glass sheet was lifted, the intensity of the laser beam could be reduced to 650 W. At a medial portion of the glass sheet, the intensity of the laser beam could be further reduced to 600 W. From a position (point a2) spaced apart from the trailing end of the glass sheet by about 10 mm, a laser beam having an intensity of 400 W was irradiated.

As such, it is appreciated that, before the glass sheet is lifted, that is, at the initial stage, a relatively high laser beam intensity is required, but, after the glass sheet is lifted, that is, around the medial portion, a reduced laser beam intensity is required, and, at the final stage, that is, around the trailing end of the glass sheet, a further reduced laser beam intensity is required.

The glass sheet used in the case of FIG. 7(b) had a rounded leading end and a trailing end which was cut straight by a laser beam, and the cutting length thereof was 581 mm and the width thereof was 1930 mm.

To crack the glass sheet, at an initial stage, a laser beam having an intensity of 800 W was irradiated onto the glass sheet to form the crack. From the state (point b1) in which the glass sheet was lifted, the intensity of the laser beam could be reduced to 600 W. From a position (point b2) spaced apart from the trailing end of the glass sheet by about 10 mm, a laser beam having an intensity of 100 W was required.

As such, it is to be appreciated that, before the glass sheet is lifted, that is, in the initial stage, a relatively high laser beam intensity is required, but, after the glass sheet is lifted, that is, around the medial portion, a reduced laser beam intensity is required, and, at the final stage, that is, around the trailing end of the glass sheet, a further reduced laser beam intensity is required.

As appreciated in the graphs showing the results of the experiment, in the initial stage, a laser beam intensity (800 W) sufficient to form a crack in the glass sheet must be irradiated. After the glass sheet has been lifted, the intensity of the laser beam is reduced to a relatively low intensity (650 W, 600 W). Finally, after the laser beam has approached the trailing end of the glass sheet, the intensity of the laser beam is further reduced (400 W, 100 W), thus the glass sheet can be cut using relatively little energy such that cut ends of the glass sheet have superior quality.

Furthermore, as can be appreciated by comparing FIGS. 7(a) and 7(b), because the tendency for cut parts of the glass sheet, which is lifted, to move in opposite directions increases as the width of the glass sheet increases, in the case of FIG. 7(a), having a width of 1633 mm, the glass sheet can be cut by a laser beam having an intensity of 400 W around the trailing end of the glass sheet, but, in the case of FIG. 7(b), having a width of 1930 mm, the glass sheet can be cut by a laser beam having an intensity of only 100 W around the trailing end of the glass sheet.

In addition, the required intensity of the laser beam varies depending on whether the trailing end of the glass sheet is rounded, as shown in FIG. 7(a), or has been cut straight by a laser beam.

That is, in the case where the trailing end of the glass sheet is rounded, a laser beam intensity higher than in the case where the trailing end of the glass sheet is cut straight by a laser beam is required.

Meanwhile, upper and lower reflecting plates may be respectively provided above and below the glass sheet such that a laser beam is repeatedly irradiated onto the glass sheet when cutting the glass sheet. In this case, it is preferable that the diameter of the upper reflecting plate be approximately 1 inch and the distance between the upper and lower reflecting plates be approximately 15 mm or less.

The upper reflecting plate is disposed directly above the lower reflecting plate and has at the center thereof a passing hole through which a laser beam passes.

The reason for this is that, if the upper reflecting plate is excessively large or the distance between the upper and lower reflecting plates is excessively great, the reflection area between the upper and lower reflecting plates increases and the number of reflections of the laser beam increases, therefore the amount of energy applied to the part of the glass sheet to be cut is reduced, thereby the cut ends of the glass sheet are inferior and, in particular, burrs may be created on the leading end of the glass sheet.

Furthermore, the reason is that, if the upper reflecting plate is excessively small, the number of reflections of the laser beam from the reflecting plates is reduced, so that the amount of energy of the laser beam applied to the glass sheet is reduced, thus it is difficult to cut the glass sheet.

The glass cutting apparatus having the bending unit and the method of cutting glass using the same according to the present invention are not limited to the above-mentioned embodiments, and various modifications, additions and substitutions are possible, without departing from the scope and spirit of the present invention.

1. A glass cutting apparatus, comprising:
a laser generating unit generating a laser beam and radiating the laser beam onto a glass sheet while moving forwards or backwards;
a stage unit provided below the laser generating unit and supporting the glass sheet, formed a guide path at a medial position;
a bending unit provided in the guide path at a position adjacent to the laser generating unit and disposed such that an upper end thereof is higher than an upper surface of the stage unit, the upper end of the bending unit contacting the glass sheet; and
a moving means for moving the bending unit.

2. The glass cutting apparatus according to claim 1, wherein the bending unit comprises:
a body moving forwards and backwards along the guide path;
a roller or ball provided on an upper end of the body and contacting the glass sheet; and
a bending height adjusting member to adjust a height of the roller or ball.

3. The glass cutting apparatus according to claim 1, wherein an air suction hole communicating with a vacuum pump is formed in the stage unit.

4. The glass cutting apparatus according to claim 1, wherein the moving means comprises a support unit coupling and fastening the bending unit to the laser generating unit, wherein
the support unit extends from the laser generating unit in a sideways direction, surrounds a side edge of the stage unit, and is coupled to the bending unit.

5. The glass cutting apparatus according to claim 1, wherein the moving means comprises a support unit coupling and fastening the bending unit to the laser generating unit, wherein
the support unit is mounted to a rear portion of the laser generating unit and is coupled to the bending unit.

6. The glass cutting apparatus according to claim 1, wherein the moving means comprises:
a first carrying unit moving the laser generating unit forwards and backwards;
a second carrying unit moving the bending unit forwards and backwards; and
a control unit controlling moving speeds of the first carrying unit and the second carrying unit.

7. A method of cutting glass using a laser beam, comprising:
an irradiating step of radiating a laser beam onto a glass sheet to form a crack in the glass sheet; and
a cutting step of cutting the glass sheet by lifting a portion of the glass sheet at which the crack is formed.

8. The method of cutting the glass using a laser beam according to claim 7, wherein, at the cutting step, a bending unit follows the laser generating unit at a speed equal to a moving speed of the laser generating unit radiating the laser beam while lifting the glass sheet.

9. The method of cutting the glass using a laser beam according to claim 7, wherein, at the irradiating step, after the glass sheet is lifted at the cutting step, the laser beam is radiated onto the glass sheet at an intensity lower than that before the glass sheet is lifted.

10. The method of cutting the glass using a laser beam according to claim 7, wherein, at the irradiating step, the laser beam is gradually reduced in intensity from a leading end of the glass sheet to a trailing end.

11. The method of cutting the glass using a laser beam according to claim 7, wherein, at the irradiating step, in a case where a trailing end of the glass sheet is rounded, a laser beam is irradiated onto the glass sheet at an intensity of higher than in a case where the trailing end of the glass sheet is cut straight.

12. The glass cutting apparatus according to claim 2, wherein an air suction hole communicating with a vacuum pump is formed in the stage unit.

13. The method of cutting the glass using a laser beam according to claim 8, wherein, at the irradiating step, after the glass sheet is lifted at the cutting step, the laser beam is radiated onto the glass sheet at an intensity lower than that before the glass sheet is lifted.

14. The method of cutting the glass using a laser beam according to claim 8, wherein, at the irradiating step, the laser beam is gradually reduced in intensity from a leading end of the glass sheet to a trailing end.

15. The method of cutting the glass using a laser beam according to claim 8, wherein, at the irradiating step, in a case where a trailing end of the glass sheet is rounded, a laser beam is irradiated onto the glass sheet at an intensity of higher than in a case where the trailing end of the glass sheet is cut straight.
